(19) United States
(12) Patent Application Publication
(10) Pub. No.: US 2017/0097323 A1
(43) Pub. Date: Apr. 6, 2017

(54) SYSTEM AND METHOD FOR DETECTING DEFECTS IN STATIONARY COMPONENTS OF ROTARY MACHINES

(71) Applicant: General Electric Company, Schenectady, NY (US)

(72) Inventors: Prashanth D'SOUZA, Bangalore (IN); Nilesh TRALSHAWALA, Rexford, NY (US); Ravi YOGANATHA BABU, Bangalore (IN); Shivanand BHAVIKATTI, Bangalore (IN); Bubathi MURUGANANTHAM, Bangalore (IN)

(21) Appl. No.: 15/279,578

(22) Filed: Sep. 29, 2016

(30) Foreign Application Priority Data
Oct. 5, 2015 (IN) 5323/CHE/2015

(51) Int. Cl. G01N 29/14; G01N 29/50; G01N 29/42

(52) U.S. Cl. CPC G01N 29/14; G01N 29/42; G01N 29/50; G01N 2291/014; G01N 2291/0289; G01N 2291/106; G01N 2291/2693; F01D 21/003

(57) ABSTRACT

A method implemented by at least one processor, includes receiving an acoustic signal from an acoustic emission sensor disposed at a predetermined location on a casing of a rotary machine operating in a transient condition. The method further includes applying a signal envelope extraction technique to the acoustic signal to generate a transformed acoustic signal. The method also includes generating an acoustic signature signal based on the transformed acoustic signal and determining a crack defect on a stationary component of the rotary machine based on the acoustic signature signal.

### BACKGROUND

Embodiments of the present invention relate generally to monitoring systems, and in particular, to a system and a method for determining crack defects in stationary components of a rotary machine.

Stationary components such as stator vanes are used in rotary machines such as compressors, turbines, engines, and the like. An axial compressor, for example, has a series of stages with each stage including a row of rotor blades and a row of stator blades. The rotor blades increase kinetic energy of a fluid that enters through an inlet of the axial compressor. The stator blades generally convert the increased kinetic energy of the fluid into static pressure through diffusion.

Humidity and high temperature may lead to corrosion of vanes inside a rotary machine. Further, low cycle fatigue and high cycle fatigue during operation of the rotary machine, may lead to stress-corrosion cracking of the vanes. Vanes may be subjected to abnormal resonances or impact of foreign objects. Additionally, the vanes may operate for long hours under different operating conditions such as high speed, high pressure, and high temperature that may affect the health of the vanes. Further, vanes may be subjected to centrifugal forces, vibratory stresses, load of a fluid, or the like. A prolonged increase in stress and fatigue over a period of time may result in crack defects in the vanes of the machine.

Inspection techniques are commonly used to detect cracks and other defects in complex parts and structures. Borescope inspection is one of the commonly used technique for monitoring vanes. Condition based maintenance of machines relies on data obtained from such an inspection. Borescope inspection techniques are dependent on operator skill and thus are very subjective. Most conventional inspection techniques for crack detection involve a static inspection process when the machine is offline. In other words, the techniques require shutdown of the machine.

There is a need for an enhanced system and method for detecting crack defects in real time in stationary components of a rotary machine.

### BRIEF DESCRIPTION

In accordance with one aspect of the present invention, a method is disclosed. The method includes receiving an acoustic signal from an acoustic emission sensor disposed at a predetermined location on a casing of a rotary machine operating in a transient condition. The method further includes applying a signal envelope extraction technique to the acoustic signal to generate a transformed acoustic signal. The method also includes generating an acoustic signature signal based on the transformed acoustic signal and determining a crack defect on a stationary component of the rotary machine based on the acoustic signature signal.

In accordance with another aspect of the present invention, a monitoring system for a rotary machine is disclosed. The monitoring system includes a stationary component disposed within a casing and an acoustic emission sensor disposed at a predetermined location on the casing. The acoustic emission sensor is configured to measure an acoustic signal when the rotary machine is operating in a transient condition. The monitoring system further includes a signal acquisition unit communicatively coupled to the acoustic emission sensor and configured to receive the acoustic signal. The monitoring system also includes a health monitoring unit communicatively coupled to the signal acquisition unit and configured to apply a signal envelope extraction technique to the acoustic signal to generate a transformed acoustic signal. The health monitoring system is further configured to generate an acoustic signature signal based on the transformed acoustic signal. The health monitoring system is also configured to determine a crack defect on the stationary component based on the acoustic signature signal.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 is a block diagram of a monitoring system for a rotary machine in accordance with an exemplary embodiment;

FIG. 2 is a graphical representation of a Campbell diagram in accordance with an exemplary embodiment;

FIG. 3 is a schematic diagram representative of signal processing within a health monitoring unit in accordance with an exemplary embodiment of FIG. 1;

FIGS. 4A, 4B, 4C, and 4D are graphical representations for detection of a crack in a stator blade from a simulated acoustic signal having low signal to noise ratio in accordance with an exemplary embodiment;

FIGS. 5A, 5B, 5C, and 5D are graphical representations for detection of a crack in a stator blade from a simulated acoustic signal having high signal to noise ratio in accordance with an exemplary embodiment;

FIG. 6 is a look-up table used for determining length of a crack defect in accordance with an exemplary embodiment; and

FIG. 7 is flow chart illustrating a plurality of steps involved in monitoring a rotary machine in accordance with an exemplary embodiment.

### DETAILED DESCRIPTION

Exemplary embodiments of the present invention include a method and a system for detecting a defect in a stationary component of a rotary machine. The method involves receiving an acoustic signal from an acoustic emission sensor disposed at a predetermined location on a casing of the rotary machine. The acoustic signal is acquired when the rotary machine is operating in a transient condition. A transformed acoustic signal is generated by applying a signal envelope extraction technique to the acoustic signal. An acoustic signature signal is generated by processing the transformed acoustic signal. A crack defect is detected on the stationary component of the rotary machine based on the acoustic signature signal.

As discussed herein, the term “rotary machine” may refer generally to any rotary electrical or mechanical machine. The term rotary machine includes, but is not limited to, an electrical motor, a diesel generator, a gas turbine and a compressor. As discussed herein, the terms “stationary component”, “blade”, “vane”, “foil” may be used interchangeably. The term “vibration mode” refers to inherent axial, flexural and torsional modes of vibrations that are generated in at least one of a stationary component such as a stator vane of the rotary machine at specific resonant frequencies. The term “flexural mode” refers to behavior of at least one of a stationary component subjected to an external load applied perpendicularly to a longitudinal axis of at least one the stationary component. The term “torsional mode” refers to angular vibrations of at least one of a stationary component. The term “acoustic emission” refers to transient elastic waves within at least one of a stationary component, generated due to the rapid release of localized stress energy. Specifically, the acoustic emissions are generated either during the propagation of crack or when the cracked surfaces of a component rub against each other during cyclical flexure and relaxation of the component. The term “acoustic signal” refers to a signal representative of acoustic emission (AE) signals having frequencies between 10 kilohertz (kHz) to 1 megahertz (MHz). The term “crack defect” refers to any defect on a stationary component that may affect the working condition of the rotary machine. The crack defect may be an incipient crack, a crack, or a propagation of crack through the material of a stationary component generated due to stress and strain levels. As discussed herein, the terms “defect” and “crack defect” may be used interchangeably. A defect such as a crack or a propagation of a crack acts as source for acoustic emissions. Additionally, the crack defect can also modify the mechanical resonant frequencies and other characteristics of vibration modes of a corresponding stationary component.

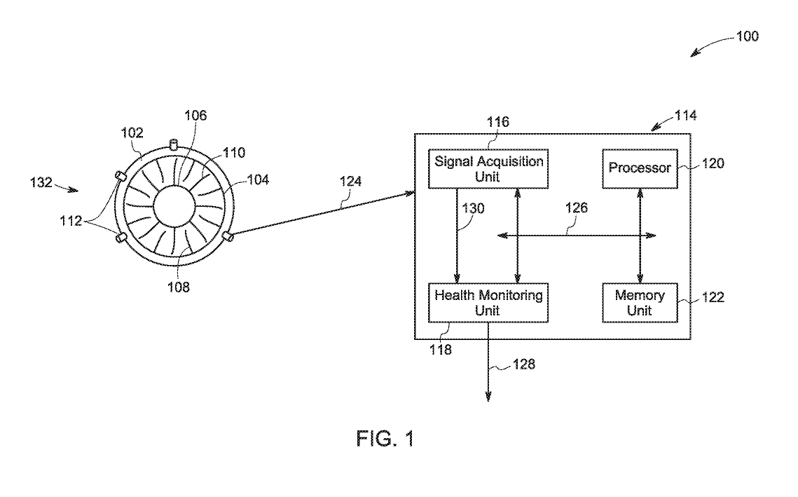

FIG. 1 is a block diagram of a monitoring system 100 for a rotary machine 132 in accordance with an exemplary embodiment. The monitoring system 100 includes a plurality of acoustic emission sensors 112 disposed at a plurality of predetermined locations on a casing 102 of the rotary machine 132. Each of the plurality of acoustic emission sensors 112 has specified bandwidth and sensitivity characteristics. In one embodiment, at least one acoustic emission sensor 112 includes a resonance model having a narrow bandwidth. In another embodiment, at least one acoustic emission sensor 112 includes a wide bandwidth model. In yet another embodiment, at least one acoustic emission sensor 112 includes a sensitive model having a very high signal-to-noise ratio. In such embodiments, the acoustic emission sensor 112 may be a piezoelectric based sensor. In an alternative embodiment, the acoustic emission sensor 112 may be an optical sensor such as, but not limited to, a fiber Bragg grating based sensor. The plurality of acoustic emission sensors 112 is configured to generate one or more acoustic signals representative of acoustic emissions when the rotary machine 132 is operating in a transient condition. The number of acoustic emission sensors 112 may vary depending on the application. The monitoring system 100 further includes a processing system 114 having a signal acquisition unit 116, a processor 120, a memory unit 122, and a health monitoring unit 118 communicatively coupled to each other via a communications bus 126. The processing system 114 receives one or more acoustic signals 124 from the plurality of acoustic emission sensors 112 and generates an output signal 128 indicative of a crack defect. The processing system 114 may also receive the rotational speed information from e.g. the rotary machine's electronic controller or via an optical/electromagnetic shaft speed encoder and associated electronics. The rotary machine 132 includes a stator 104 having a plurality of stator vanes (also referred to as “stationary components”) 108 and a rotor 106 having a plurality of rotor vanes 110 disposed with the casing 102.

The signal acquisition unit 116 is communicatively coupled to the plurality of acoustic emission sensors 112 and configured to receive at least one acoustic signal 124 when the rotary machine 132 is operating in a transient condition. The term “transient condition” refers to at least one of a start-up condition and a shut-down condition of the rotary machine 132. The start-up condition is indicative of a condition when the rotational speed of the rotary machine 132 is increased from an idle condition to a stable operating speed. The shut-down condition is indicative of a condition when the rotational speed of the rotary machine 132 is decreased from a stable operating speed to the idle condition. During the transient condition, the rotary machine 132 operates at a plurality of rotational speeds thereby exciting a plurality of vibration modes in the vanes 108. When the rotational speed of the rotary machine 132 reaches a critical speed, a vibrational mode corresponding to the critical speed is excited in the vanes 108. As a result, an acoustic signal having an amplitude modulation corresponding to the vibrational mode frequency may be generated depending on whether at least one of the plurality of vanes 108 has a crack defect. During the transient condition, the rotary machine 132 may operate at a plurality of critical speeds. As a result, a plurality of acoustic signals having a plurality of frequencies in a frequency range of 10 kHz to 1 MHz and amplitude modulations corresponding to a plurality of vibrational modes may be generated depending on whether at least one of the plurality of vanes 108 has a crack defect.

The at least one acoustic signal 124 is representative of information about existence of a crack defect in one or more stator vanes 108 disposed within the casing 102. Although “stator vanes” are referenced herein for purposes of illustration, other static structures subject to vibration modes and disposed within the casing 102 may additionally or alternatively be monitored. In one embodiment, the signal acquisition unit 116 is further configured to sample the acoustic signal 124 by processing steps such as noise filtering and signal normalization to enhance the signal content and provide a processed acoustic signal 130 to the health monitoring unit 118. In certain embodiments, when the received acoustic signal 124 has high signal-to-noise ratio, additional processing may not be required and the received acoustic signal 124 is transmitted to the health monitoring unit 118.

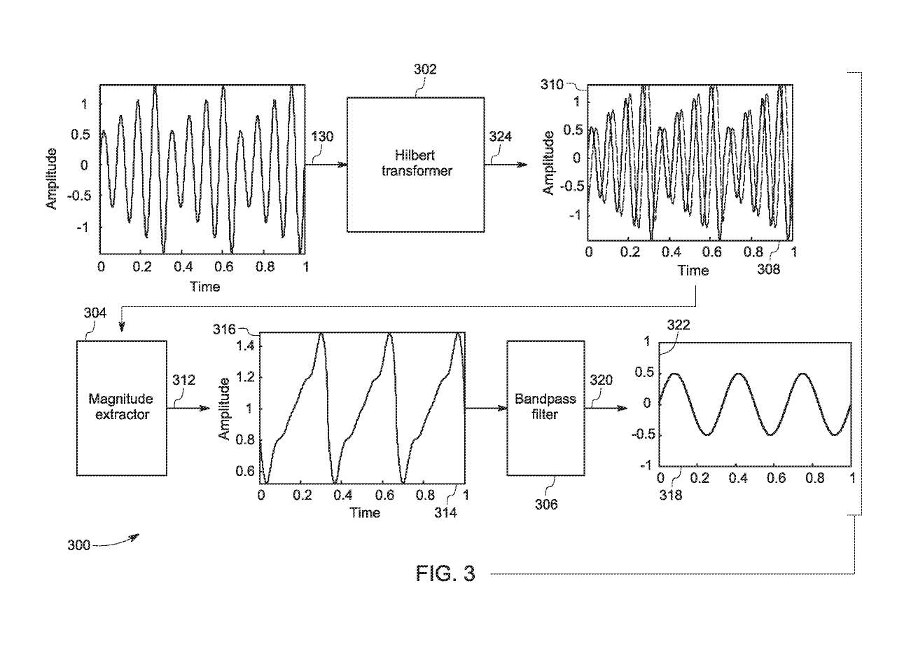

The health monitoring unit 118 is communicatively coupled to the signal acquisition unit 116 and configured to receive the processed acoustic signal 130. As illustrated in more detail with respect to FIG. 3, the health monitoring unit 118 is further configured to generate a transformed acoustic signal by applying a signal envelope extraction technique to the processed acoustic signal 130. In one embodiment, a Hilbert transformation is used for generating the transformed acoustic signal. In another embodiment, a half wave rectification followed by a low pass filtering is used for generating the transformed acoustic signal. In another embodiment, a full wave rectification followed by a low pass filtering is used for generating the transformed acoustic signal. The health monitoring unit 118 is also configured to generate an acoustic signature signal based on the transformed acoustic signal. In one embodiment, the acoustic signature signal is generated by filtering the transformed acoustic signal via a plurality of low pass filter. In another embodiment, the acoustic signature signal is generated by filtering the transformed acoustic signal via a plurality band-pass filters. Each band-pass filter has center frequency corresponding to a vibration frequency of a corresponding vibration mode of the stator vanes 108. In one embodiment, a band-pass filter has a lower cut off frequency in a range of fifty hertz to ten kilohertz and a bandwidth of five hundred hertz. The health monitoring unit 118 is further configured to detect the crack defect based on the acoustic signature signal. In an exemplary embodiment, the crack defect is detected in one of the stator vanes based on a peak value of the acoustic signature signal. In one specific embodiment, the acoustic signature signal may be compared with a predetermined threshold limit. When a portion of the acoustic signature signal exceeds the predetermined threshold limit, an output signal 128 indicative of the crack defect is generated.

In some embodiments, the health monitoring unit 118 is also configured to process a plurality of acoustic signals 124 to determine a length and a position of the crack defect. In one such embodiment, a resonant frequency of the acoustic signature signal is determined. A length of the crack is obtained from a look-up table based on the value of the resonant frequency. The look-up table may be stored in the memory unit 122 and the values of the look-up table are pre-populated based on historical data and a plurality of observations obtained from experiments or computer simulations. In an alternate embodiment, the length of the crack is obtained by evaluating a mathematical expression as a function of the resonant frequency. In another such embodiment, a source localization technique is used to process the plurality of acoustic signals 124. In one specific embodiment, the source localization technique is a MUSIC (multiple signal classifier) technique. In another embodiment, the source localization technique is an ESPRIT (estimation of signal parameters via rotational invariance technique) technique. In an exemplary embodiment, for each pair of acoustic emission sensors among the plurality of acoustic emission sensors, a time difference of arrival (TDOA) is estimated from the acoustic signals detected by the corresponding pair of acoustic emission sensors. As a result, a plurality of such TDOA estimates for a plurality of pairs of acoustic emission sensors is determined. The position of the crack defect is determined based on a location of the source of the acoustic emission corresponding to the plurality of acoustic signals received from the plurality of acoustic emission sensors. In other embodiments, a triangulation based technique is employed to determine the position of the crack defect.

The processor 120 may include one or more sub-processors having at least one arithmetic logic unit, a microprocessor, a general purpose controller or a processor array to perform the desired computations or execute the computer program. In one embodiment, the functionality of the processor 120 may be limited to tasks performed by the signal acquisition unit 116. In another embodiment, the functionality of the processor 120 may be limited to functions performed by the health monitoring unit 118. The processor 120 is configured to execute a program stored in the memory.

The memory unit 122 is configured to be accessed by at least one of the signal acquisition unit 116, the health monitoring unit 118, and the processor 120. In an exemplary embodiment, the memory unit 122 may include one or more memory modules. The memory unit 122 may be a non-transitory storage medium. For example, the memory unit 122 may be a dynamic random access memory (DRAM) device, a static random access memory (SRAM) device, flash memory or other memory devices. In one embodiment, the memory unit 122 may include a non-volatile memory or similar permanent storage device, media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices. In one specific embodiment, a non-transitory computer readable medium may be encoded with a program to instruct at least one processor to perform functions of one or more of the signal acquisition unit 116 and the health monitoring unit 118.

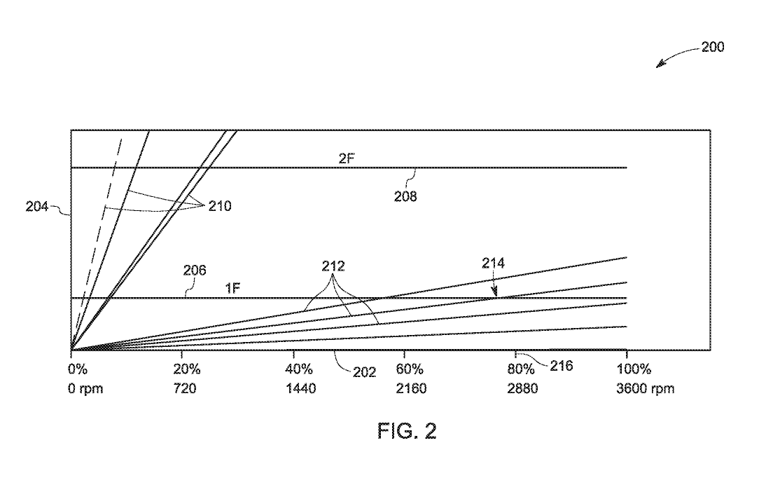

FIG. 2 is a graph 200 representative of a Campbell diagram in accordance with an exemplary embodiment. The graph 200 includes a horizontal axis 202 representative of speed of a rotary machine and a vertical axis 204 representative of resonant frequency corresponding to vibration modes of a plurality of stator vanes of the rotary machine. The graph 200 further includes a plurality of horizontal lines 206, 208 representative of resonant frequencies corresponding to the vibration modes of the stator vanes. In the illustrated embodiment, the horizontal line 206 corresponds to a first flexural vibrational mode and the horizontal line 208 corresponds to a second flexural vibrational mode. The graph 200 further includes a plurality of diagonal lines 210, 212 having slopes that are integral multiples of a rotational speed of the rotary machine. The diagonal lines 210 intersect both the horizontal lines 206, 208 at points corresponding to rotational speeds less than 1000 rpm. The plurality of diagonal lines 212 intersect the horizontal line 206 at points corresponding to rotational speeds between 1800 rpm and 3000 rpm. Corresponding rotational speeds at which the diagonal lines 210, 212 intersect the horizontal line 206 are indicative of critical machine speeds for the first vibrational mode. Further, corresponding rotational speeds at which the diagonal lines 210 intersect the horizontal line 208 are indicative of critical machine speeds for the second vibrational mode. In one embodiment, when the machine operates at a critical speed represented by a point 216, the first vibrational mode is excited and the stator vanes vibrate at a frequency of about one hundred and thirty six hertz. One of the plurality of diagonal lines 212 intersects the horizontal line 206 at an operating point 214, corresponding to the critical speed represented by the operating point 216.

FIG. 3 is a schematic diagram 300 representative of signal processing within a health monitoring unit 118 in accordance with an exemplary embodiment of FIG. 1. The health monitoring unit 118 includes a Hilbert transformer 302 and a band-pass filter 306. The Hilbert transformer 302 receives the processed acoustic signal 130 and generates an analytic signal 324 having real and imaginary component signals. The real and imaginary component signals of the analytic signal 324 are illustrated by a graph having an x-axis 308 representative of time and a y-axis representative of amplitude. In other embodiments, other signal transformations such as, but not limited to, Hartley transform and cepstrum may be used to generate the transformed signal. The transformed acoustic signal 312 is generated by extracting magnitude of the analytic signal 324, using a magnitude extractor 304. The transformed acoustic signal 312 is illustrated by a graph having an x-axis 314 representing time and a y-axis 316 representative of amplitude. An acoustic signature signal 320 is generated from the transformed acoustic signal 312, using a band-pass filter 306. The band-pass filter 306 has a center frequency corresponding to a vibration signal of the stator vane. The vibration frequency of the stator vane is a frequency in range of 50 Hz to 10 kHz. The bandwidth of the band-pass filter 306 is about five hundred hertz. In other embodiments, the transformed acoustic signal 312 is further processed using a demodulator to translate the frequency component to baseband.

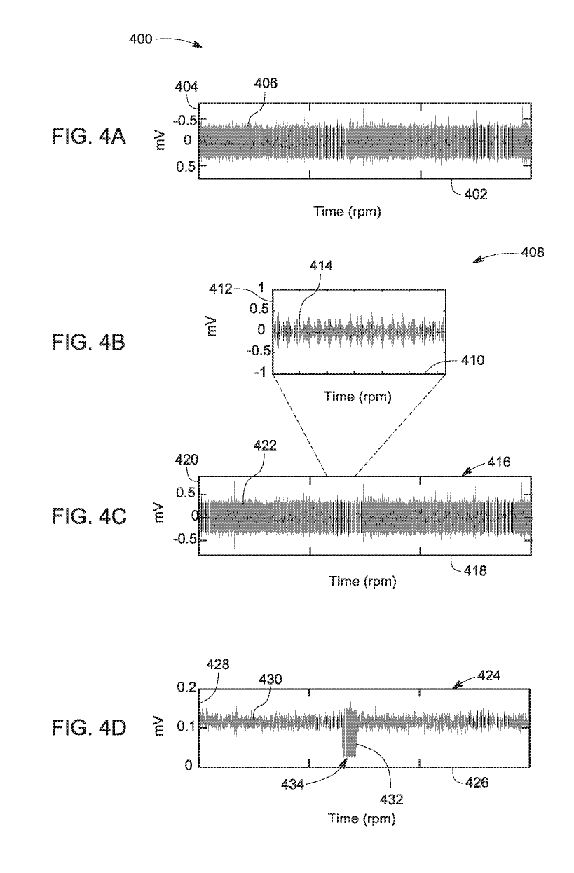

FIG. 4A is a graphical representation 400 having an x-axis 402 representative of time and a y-axis 404 representative of amplitude. The x-axis 402 is also representative of angular speed expressed in rotations per minute (RPM). The curve 406 is representative of background vibration signal (i.e. background acoustic emission noise) from a machine which does not have a cracked vane.

FIG. 4B is a graphical representation 408 having an x-axis 410 representative of time and a y-axis 412 representative of amplitude. The curve 414 is representative of an acoustic emission signal corresponding to mechanical vibrations of a cracked vane.

FIG. 4C is a graphical representation 416 having an x-axis 418 representative of time and a y-axis 420 representative of amplitude. The curve 422 is representative of a simulated acoustic signal from a vane having a crack defect. The acoustic signal is recorded from a sensor disposed on the casing of a machine. The curve 422 is representative of a simulated acoustic signal which includes the background vibration signal represented by the curve 406 of FIG. 4A and the acoustic emission signal from a vane having a crack defect is represented by the curve 414 of FIG. 4B. The acoustic emission signal represented by the curve 414 is representative of the signal component and the background vibration signal represented by the curve 406 is representative of the noise component. The simulated acoustic emission signal represented by the curve 422, has a low SNR (Signal to Noise Ratio).

FIG. 4D is a graphical representation 424 having an x-axis 426 representative of time and a y-axis 428 representative of amplitude. A curve 430 is representative of an acoustic signature signal. The simulated acoustic signal represented by the curve 422 of FIG. 4C is processed to generate the acoustic signature signal. A peak value (434) of a portion 432 of the curve 430 is representative of a crack defect. With reference to FIGS. 4A-4D, the crack defect is detected in the presence of high levels of background vibration signals.

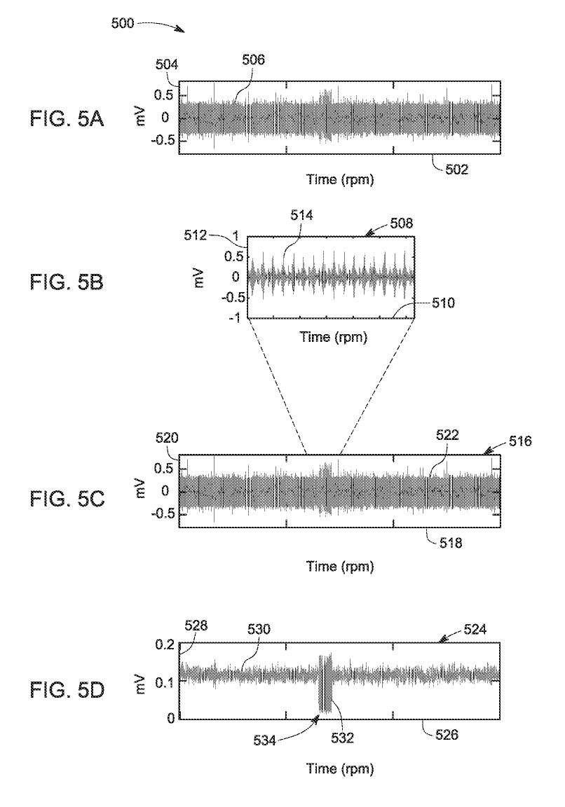

FIG. 5A is graphical representation 500 having an x-axis 502 representative of time and a y-axis 504 representative of amplitude. The x-axis 502 is also representative of angular speed expressed in rotations per minute (RPM). A curve 506 is representative of a background vibration signal from a machine which does not have a cracked vane.

FIG. 5B is a graphical representation 508 having an x-axis 510 representative of time and a y-axis 512 representative of amplitude. The curve 514 is representative of an acoustic emission signal corresponding to mechanical vibrations of a cracked vane.

FIG. 5C is a graphical representation 516 having an x-axis 518 representative of time and a y-axis 520 representative of amplitude. The curve 522 is representative of a simulated acoustic signal from a vane having a crack defect. The acoustic signal is recorded from a sensor disposed on the casing of a machine. The simulated acoustic signal represented by the curve 522 includes the background vibration signal represented by the curve 506 of FIG. 5A and the acoustic emission signal from a vane having a crack defect is represented by the curve 514 of FIG. 5B. The acoustic emission signal represented by the curve 514 is the signal component and the background vibration signal represented by the curve 506 is the noise component. The simulated acoustic emission signal has a good SNR (Signal to Noise Ratio).

FIG. 5D is a graphical representation 524 having an x-axis 526 representative of time and a y-axis 528 representative of amplitude. A curve 530 is representative of an acoustic signature signal. The simulated acoustic signal represented by the curve 522 of FIG. 5C is processed to generate the acoustic signature signal. A peak value (534) of a portion 532 of the curve 530 is representative of a crack defect. With reference to FIGS. 5A-5D, the crack defect is detected in the presence of low levels of background vibration signals.

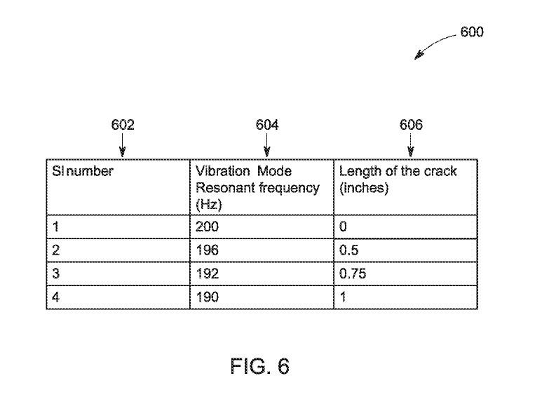

FIG. 6 is a look-up table 600 used to determine a length of a crack defect in accordance with an exemplary embodiment. The look-up table 600 includes a plurality of columns 602, 604, 606. The column 602 includes a plurality of index entries, the column 604 includes a plurality of resonant frequency values, and the column 606 includes a plurality of crack defect lengths. In one embodiment, the look-up table 600 is stored in a memory unit and accessed by a health monitoring unit. The health monitoring unit is configured to retrieve an index entry value from the look-up table 600 based on a resonant frequency value obtained from the acoustic signature signal. Further, the health monitoring unit is configured to retrieve a length value of the crack defect based on the index entry value. As an example, for a resonant frequency of 190 Hz, the crack defect length is determined as 0.75 inch.

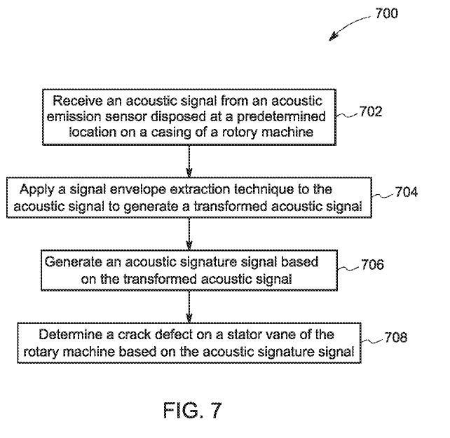

FIG. 7 is a flow chart 700 illustrating a plurality of steps for monitoring a rotary machine in accordance with an exemplary embodiment. The method involves receiving an acoustic signal from an acoustic emission sensor disposed at a predetermined location on a casing of a rotary machine as illustrated in step 702. The method further involves applying a signal envelope extraction technique to the acoustic signal to generate a transformed acoustic signal as illustrated in step 704. The method also involves generating an acoustic signature signal based on the transformed acoustic signal as illustrated in step 706.

The method further involves determining a crack defect on a stator vane of the rotary machine based on the acoustic signature signal as represented in step 708. In one embodiment, a plurality of samples of the acoustic signature signal is compared with a predetermined threshold value. If samples of the acoustic signature signal are greater than the predetermined threshold value, a peak value in the acoustic signature signal is detected. The peak in the acoustic signature signal is indicative of a crack defect in one or more of the stator vanes. In an embodiment involving a plurality of acoustic signature signals, crack defect is independently determined from each of the plurality of acoustic signature signals. The determined data related to the detection of crack defect may be combined to determine a robust decision pertaining to the detection of the crack defect. In another embodiment, the data related to the crack defect may be indicative of a plurality of crack defects in one or more of the stator vanes.

In an exemplary embodiment, determining the crack defect involves determining at least one of a length and a position of the crack defect, based on the acoustic signature signal. Determining the length of the crack defect involves determining a resonant frequency corresponding to the acoustic signature signal. The length of the crack defect is obtained from a look-up table, using the resonant frequency. In another embodiment, a plurality of acoustic signals is obtained from a plurality of acoustic emission sensors disposed at a plurality of predetermined locations on the casing of the rotary machine. In such an embodiment, determining a position of the crack defect involves processing a plurality of acoustic signals from the plurality of acoustic emission sensors disposed at a plurality of predetermined locations on the casing of the rotary machine. The location of the crack defect is determined based on a source localization technique. In one embodiment, the source localization technique is a triangulation technique based on at least three acoustic signals. In another embodiment, a time difference of arrival (TDOA) is determined corresponding to a pair of acoustic signals from the plurality of acoustic signals. A plurality of such TDOA estimates is obtained corresponding to the plurality of pairs of acoustic signals, from the plurality of acoustic signals. The location of the crack defect is obtained based on the plurality of TDOA estimates. In one embodiment, the position of the crack defect is determined based on the plurality of transformed acoustic signals. In another embodiment, the position of the crack defect is determined based on the plurality of acoustic signature signals.

Disclosed embodiments facilitate detection of crack defects in-situ in stationary components such as stator vanes in rotary machines. Monitoring presence and growth of crack defects on the stator vanes is enabled by signal processing of acoustic emission signals obtained from acoustic emission (AE) sensors disposed on the casing. The exemplary inspection techniques for crack detection can be performed in real time when the machine is operating. In other words, the exemplary technique does not require shutdown of the machine.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims.

What is claimed is:

1. A method comprising:
receiving an acoustic signal from an acoustic emission sensor disposed at a predetermined location on a casing of a rotary machine operating in a transient condition;
applying a signal envelope extraction technique to the acoustic signal to generate a transformed acoustic signal;
generating an acoustic signature signal based on the transformed acoustic signal; and
determining a crack defect on a stationary component of the rotary machine based on the acoustic signature signal.

2. The method of claim 1, wherein the acoustic signal comprises a plurality of acoustic emission signals in a frequency range of 10 kilohertz to 1 megahertz.

3. The method of claim 1, wherein the acoustic emission sensor comprises at least one of a piezoelectric sensor and an optical sensor.

4. The method of claim 1, wherein generating the acoustic signature signal comprises a band-pass filtering of the transformed acoustic signal via a band-pass filter.

5. The method of claim 4, wherein the band-pass filter has a center frequency corresponding to a vibration frequency of the stationary component.

6. The method of claim 1, wherein determining the crack defect comprises determining a peak value of the acoustic signature signal.

7. The method of claim 1, further comprising determining at least one of a length and a position of the crack defect, based on the acoustic signature signal.

8. The method of claim 7, wherein determining the length of the crack defect comprises:
determining a resonant frequency corresponding to the acoustic signature signal; and
determining the length of the crack defect from a look-up table based on the resonant frequency.

9. The method of claim 7, wherein receiving the acoustic signal from the acoustic emission sensor comprises receiving a plurality of acoustic signals from a plurality of acoustic emission sensors disposed at a plurality of predetermined locations on the casing of the rotary machine.

10. The method of claim 9, wherein determining the position of the crack defect comprises processing the plurality of acoustic signals, using a source localization technique.

11. A monitoring system for a rotary machine comprising a stationary component disposed within a casing, the monitoring system comprising:
an acoustic emission sensor disposed at a predetermined location on the casing, wherein the acoustic emission sensor is configured to measure an acoustic signal when the rotary machine is operating in a transient condition;
a signal acquisition unit communicatively coupled to the acoustic emission sensor and configured to receive the acoustic signal; and
a health monitoring unit communicatively coupled to the signal acquisition unit and configured to:
apply a signal envelope extraction technique to the acoustic signal to generate a transformed acoustic signal;
generate an acoustic signature signal based on the transformed acoustic signal; and
determine a crack defect on the stationary component based on the acoustic signature signal.

12. The system of claim 11, wherein the acoustic emission sensor is configured to measure the acoustic signal comprising a plurality of acoustic emission signals in a frequency range of 10 kilohertz to 1 megahertz.

13. The system of claim 11, wherein the acoustic emission sensor comprises at least one of a piezoelectric sensor and an optical sensor.

14. The system of claim 11, wherein the health monitoring unit is further configured to generate the acoustic signature signal by band-pass filtering of the transformed acoustic signal via a band-pass filter having a center frequency corresponding to a vibrational frequency of the stationary component.

15. The system of claim 11, wherein the health monitoring unit is further configured to determine the crack defect on the stationary component by detecting a peak value in the acoustic signature signal.

16. The system of claim 11, wherein the health monitoring unit is further configured to determine at least one of a length and a position of the crack defect, based on the acoustic signature signal.

17. The system of claim 16, wherein the health monitoring unit is further configured to determine the length of the crack defect by:
determining a resonant frequency corresponding to the acoustic signature signal; and
determining the length of the crack defect from a look-up table, based on the resonant frequency.

18. The system of claim 16, wherein the acoustic emission sensor comprises a plurality of acoustic emission sensors and the predetermined location comprises a plurality of predetermined locations on the casing of the rotary machine.

19. The system of claim 18, wherein the health monitoring unit is further configured to determine the position of the crack defect by processing the acoustic signal comprising a plurality of acoustic emission signals, using a source localization technique.
